(19) United States
(12) Patent Application Publication
(10) Pub. No.: US 2021/0297427 A1
(43) Pub. Date: Sep. 23, 2021

(54) FACILITATING SECURITY ORCHESTRATION, AUTOMATION AND RESPONSE (SOAR) THREAT INVESTIGATION USING A MACHINE-LEARNING DRIVEN MIND MAP APPROACH

(71) Applicant: Fortinet, Inc., Sunnyvale, CA (US)

(72) Inventors: Abhishek Narula, Pune (IN); Christopher Carsey, Tucson, AZ (US); Amit Jain, Pune (IN); Pooja Singh, Pune (IN)

(73) Assignee: Fortinet, Inc., Sunnyvale, CA (US)

(21) Appl. No.: 16/822,259

(22) Filed: Mar. 18, 2020

(51) Int. Cl. H04L 29/06; G06N 20/00; G06N 5/04

(52) U.S. Cl. CPC H04L 63/1416; H04L 63/1425; G06N 5/04; G06N 20/00; H04L 63/1441

(57) ABSTRACT

Systems and methods for facilitating a mind map approach to a SOAR threat investigation are provided. A SOAR platform operatively coupled with a Security Operation Center (SOC) of a monitored network receives alert data pertaining to an incident. A mind map view is generated within a graphical user interface. The mind map view includes a primary node corresponding to the incident, one or more field nodes associated with the primary node, one or more action nodes based at least on one of the one or more field nodes. Each of the action nodes is associated with one or more dynamic actions selectable by an analyst. Responsive to selection of a dynamic action, at least one field node or a suggested actions associated with a corresponding action node is suggested by a machine-learning engine based on the selection. The mind map view is updated in real time to include the suggestion.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2020, Fortinet, Inc.

### BACKGROUND

### Field

Embodiments of the present invention generally relate to the field of cybersecurity and Security Orchestration, Automation and Response (SOAR). In particular, embodiments of the present invention relate to systems and methods for facilitating investigation and resolution of unknown/unplanned security threats with a SOAR system using a machine-learning driven mind map approach.

### Description of the Related Art

SOAR technologies enable Security Operation Centers (SOCs) to collect and aggregate vast amounts of security data and aid them in identifying and categorizing security events. A SOAR platform may provide members of a SOC (referred to herein as analysts) with an automated solution that helps identify and respond to unauthorized intruders and threats before they manage to get a foothold in the monitored network. Further, SOAR aims to improve remediation of threats once they are known and identified. For example, SOAR platforms may facilitate creation and management of playbooks that align with the SOC's incident response policies and consisting of quality responses, including a combination of automated operations, manual input and investigation of known or planned security threats.

Standard SOAR playbook approaches are not very effective for certain scenarios, including: (i) responding to unknown/unplanned threats, (ii) one-off threats (e.g., non-standard threats that are not likely to occur multiple times), and (iii) threat hunting (which typically involves the use of a variety of tools and sources to look for potential threats in an environment in a manner that may not be repeated). For example, since a playbook does not exist for such incidents, responding to unknown/unplanned threats, one-off threats, or alerts for which a process has yet to be established remains a challenge for analysts. As such, analysts must manually investigate the alerts and related evidence and may subsequently develop a playbook based on the steps undertaken during the manual investigation.

### SUMMARY

Systems and methods are described for facilitating a mind map approach to a Security Orchestration, Automation and Response (SOAR) threat investigation. According to one embodiment, alert data pertaining to an incident observed within a monitored network is received by a SOAR platform. As part of an investigation into the incident and based on the received alert data, a mind map view is presented within a graphical user interface (GUI) of a console used by an analyst. The mind map view includes a primary node corresponding to the incident, one or more field nodes associated with the primary node, and one or more action nodes based at least on one of the one or more field nodes. Each of the one or more action nodes is associated with one or more dynamic actions selectable by the analyst to be executed by the SOAR platform. Information is received by the SOAR platform regarding a selected action of the one or more dynamic actions selected by the analyst. A machine-learning model is trained by the SOAR platform based on the incident and the selected action. The mind map view is updated by the SOAR platform in real-time based on a suggestion by the machine-learning model.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a network architecture in which an example embodiment may be implemented in accordance with an embodiment of the present invention.

FIG. 2 is a block diagram illustrating functional components of a SOAR platform in accordance with an embodiment of the present invention.

FIGS. 3A-E illustrate exemplary representations of various stages of a mind map approach to a SOAR threat investigation in accordance with an embodiment of the present invention.

FIG. 4 illustrates an exemplary screen shot containing event data gathered via a mind map in accordance with an embodiment of the present invention.

FIG. 5 is a flow diagram illustrating interactions between a machine learning model and the investigation process performed via a mind map in accordance with an embodiment of the present invention.

FIG. 6 is a flow diagram illustrating a process for investigating a Security Operations Center (SOC) threat using a mind map in accordance with an embodiment of the present invention.

FIG. 7 illustrates an exemplary computer system in which or with which embodiments of the present invention may be utilized.

### DETAILED DESCRIPTION

Systems and methods are described for facilitating a mind map approach to a SOAR threat investigation. In the following description, numerous specific details are set forth in order to provide a thorough understanding of embodiments of the present invention. It will be apparent to one skilled in the art that embodiments of the present invention may be practiced without some of these specific details.

Existing SOAR products have created a mechanism to streamline responses for known security threats by incorporating the use of well-established procedures for responding to common threat types (e.g., ransomware, compromised accounts, and phishing) into SOAR playbooks that facilitate automating (at least in part) responses to such security threats. However, as noted above in the Background, existing SOAR products are not very effective in assisting analysts with unknown/unplanned threats, one-off threats and threat hunting. As such, these types of threats are typically investigated by logging in to numerous tools such as Security Information and Event Management (SIEM) systems, Endpoint Detection and Response (EDR) solutions, Threat Intelligence, and others.

Embodiments described herein seek to provide an intuitive visual approach (e.g., a mind map approach) to address various of the deficiencies of current SOAR products. For example, since SOAR already integrates with SIEM, EDR, Threat Intelligence, and other tools, providing a mind map view as proposed herein is thought to enable visualization, querying, enrichment, and the taking of actions from a centralized location in SOAR. As described in further detail below, a mind map approach to a SOAR threat investigation of a SOC alert or incident allows analysts to investigate new and one-off threats, and perform threat hunting across multiple tools and sources from a single location. In various usage scenarios, the proposed mind map approach is thought to be a preferable solution to developing a playbook, since it does not require any pre-configuration or planning, and allows on-the-fly automation. Additionally, the proposed mind map approach provides a visualization that humans connect to naturally for the threat and related material.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein an “incident” generally refers to any malicious act or suspicious event observed within a private network. Such malicious acts typically (i) compromise or represent an attempt to compromise the logical border surrounding a network to which assets (e.g., programmable electronic devices and communication networks including hardware, software, and data) are connected and for which access is controlled or (ii) disrupt or represent an attempt to disrupt such assets. Non-limiting examples of types or classes of incidents include unauthorized attempts to access systems or data, privilege escalation attacks, unusual behavior from privileged user accounts, insider threats (e.g., insiders trying to access servers and data that isn't related to their jobs, logging in at abnormal times from unusual locations, or logging in from multiple locations in a short time frame), anomalies in outbound network traffic (e.g., uploading large files to personal cloud applications, downloading large files to external storage devices, or sending large numbers of email messages with attachments outside the company), traffic sent to or received from unknown locations, excessive consumption of resources (e.g., processing, memory and/or storage resources), changes in configuration (e.g., reconfiguration of services, installation of startup programs, the addition of scheduled tasks, changes to security rules or firewall changes), hidden files (may be considered suspicious due to their file names, sizes or locations and may be indicative that data or logs may have been leaked), unexpected changes (e.g., user account lockouts, password changes, or sudden changes in group memberships), abnormal browsing behavior (e.g., unexpected redirects, changes in browser configuration, or repeated pop-ups), suspicious registry entries, phishing attacks, malware attacks, denial-of-service (DoS) attacks, man-in-the-middle attacks, and password attacks.

As used herein “indicators of compromise” or simply “indicators” generally refer to pieces of forensic data that identify potentially malicious activity on a system or network. Non-limiting examples of such data include data found in system log entries or files. Indicators of compromise may aid information security and IT professionals in detecting data breaches, malware infections, or other threat activity. By monitoring for indicators of compromise, organizations can detect attacks and act quickly to prevent breaches from occurring or limit damages by stopping attacks in earlier stages. Non-limiting examples of indicators of compromise include unusual outbound network traffic, anomalies in privileged user account activity, geographical irregularities, log-in red flags, increases in database read volume, Hypertext Markup Language (HTML) response sizes, large numbers of requests for the same file, mismatched port-application traffic, suspicious registry or system file changes, unusual DNS requests, unexpected patching of systems, mobile device profile changes, bundles of data in the wrong place, web traffic with unhuman behavior, and signs of distributed DoS (DDoS) activity.

As used herein a first incident or first type of incident is “similar” or “similar in nature” to a second incident or second type of incident when their respective feature sets meet a predetermined or configurable similarity threshold. For example, in one embodiment, two incidents may be considered similar when their names or types are similar and when similar indicators are linked to both. In one embodiment, attributes associated with incident metadata (e.g., name, description, severity, phase, status, type, date, and the like) may constitute a feature set. Depending upon the particular implementation, the feature set for computing similarity may be configurable. For example, analysts or an administrator may be provided with the ability to select attributes from the incident metadata that will represent the feature set. The attributes available for selection to be included as part of a feature set may also include metadata collected from other sources (e.g., threat intel sources, SIEM, security tools, logs, and the like). In one embodiment, Term Frequency-Inverse Document Frequency (TF-IDF) similarity is used to identify similar incidents. In some embodiments, the similarity threshold may be defined as a percentage (e.g., 80%, 90% or 100%) for incidents to be considered similar. Additionally or alternatively, a timeframe may be considered. For example, only incidents created/observed within a particular timeframe (e.g., one month) may be considered similar to an incident at issue.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention are described and illustrated herein, it will be clear that the invention is not limited to these particular embodiments. Numerous modifications, changes, variations, substitutions, and equivalents will be apparent to those skilled in the art, without departing from the spirit and scope of the invention, as described in the claims.

Systems and methods are described for facilitating a mind map based approach to a SOAR threat investigation. In an embodiment, the mind map based approach addresses visualization, actions and makes use of machine learning. With respect to visualization, a graphical visualization of a mind map to which humans connect to naturally may be presented to facilitate the SOAR threat investigation. For example, instead of a tabular representation of data, the alert or incident at issue may be presented in a mind map format that shows indicators, including their relationship and available actions (connectors) on the incident at issue. The mind may also include other related entities (e.g., assets, users, etc.). According to one embodiment, the mind map may include a node representing the incident at issue in the center with suggested available actions that can be taken radiating outward.

In relation to actions, analyst actions may be enabled based on the selected entity (e.g., node) within the mind map and corresponding available actions associated with the selected entity. For example, for an Internet Protocol (IP) address, the corresponding available actions may include enrichment and/or mitigation actions.

Turning now to the use of machine learning, in one embodiment, the actions initiated by the analysts may be fed into a machine-learning engine to train the engine to suggest response procedures automatically for similar types of incidents in the future. In this manner, the machine-learning engine can be used to predict the mind map based on learning from previous analyst actions.

In an embodiment, an intuitive visual mind map approach is provided to facilitate a SOAR threat investigation of a SOC alert relating to an incident observed in a monitored network. The mind map supports a flexible and dynamic approach for investigating and responding to new and/or one-off threats for which a SOAR playbook may not exist. The SOAR platform integrates with SIEM, EDR, threat intelligence, and others tools to facilitate threat hunting across multiple tools and sources from a single location. The mind map view proposed herein enables visualization, querying, enrichment, and initiation of manual or automated actions from a centralized location in the SOAR platform. The mind map approach is a preferable solution to developing a playbook in certain scenarios (e.g., investigation of one-off threats or other incidents for which a SOAR playbook is not available and/or threat hunting). For example, as described in further detail below, the mind map approach does not require any pre-configuration or planning, and allows for on-the-fly automation.

According to an aspect of the present disclosure, a SOAR platform operatively coupled with a SOC of a monitored network receives alert data pertaining to a potential threat (an incident). Based on an investigation into the incident and the received alert data the SOAR platform generates a mind map view within a graphical user interface (GUI) of a console used by an analyst. The mind map view includes a primary node corresponding to the incident at issue, one or more field nodes associated with the primary node, one or more action nodes associated with each of the one of the one or more field nodes, wherein each of the one or more action nodes is associated with one or more dynamic actions (e.g., enrichment or mitigation actions) selectable by the analyst to be executed by the SOAR platform.

In one embodiment, the SOAR platform generates the mind map by obtaining suggestions from a machine-learning model based on learning from previous actions performed by analysts on similar incidents observed in the past. The suggested field nodes may be attached to the primary node and the suggested action nodes may be attached to the suggested field nodes. In addition, as the analyst traverses a path within the mind map the SOAR platform may update the mind map view in real-time.

While, for sake of brevity, embodiments described herein may be discussed with reference to a mind map focused on an incident at issue with the incident at issue representing the primary node of the mind map, it is to be understood in alternative embodiments the primary node of the mind map may relate to an alert, an incident or an indicator.

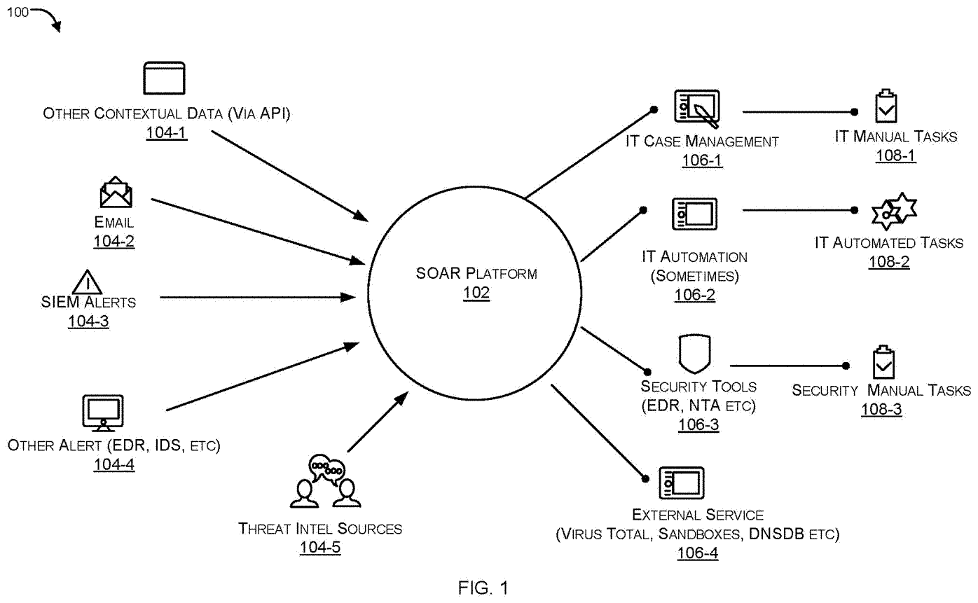

FIG. 1 is a network architecture 100 in which aspects of the present invention may be implemented in accordance with an embodiment of the present invention. In the context of the present example, a SOAR platform 102 may be operatively coupled with a SOC of a monitored network to facilitate receipt of alert data pertaining to an incident. SOAR platform 102 may represent a cloud-based SOAR service or a platform provided by a managed security service provider (MSSP). Alternatively or additionally, SOAR platform 102 may include an on-premise SOAR platform that receives data from a wide range of different sources. According to one embodiment, SOAR platform 102 is operable to apply decision making logic, combined with context, to provide formalized workflows and enable informed prioritization (triage) of remediation tasks relating to threats observed at the SOC.

Those skilled in the art will appreciate that, the monitored network can be a wireless network, a wired network or a combination thereof that can be implemented as one of the different types of networks, such as Intranet, Local Area Network (LAN), Wide Area Network (WAN), Internet, and the like. Further, the monitored network can either be a dedicated network or a shared network. A shared network may represent an association of the different types of networks that use a variety of protocols, for example, Hypertext Transfer Protocol (HTTP), Transmission Control Protocol/Internet Protocol (TCP/IP), Wireless Application Protocol (WAP), and the like.

The threat of a cyberattack can put pressure on the SOC, leading to operational disruption of the monitored network, and reputational damage. The SOAR platform 102 may facilitate identification and responding to cyberattacks by processing a large volume of alert and log data that may contain information indicative of the type and nature of an attack that may be underway. In an embodiment, the SOAR platform 102 is operable to receive and process actionable alert data pertaining to an alert, such as a phishing alert, for example, related to contextual data via Application Programming Interface (API) 104-1. API 104-1 can enable determining security alerts from multiple sources along with contextual data. At 104-2 the alert data can pertain to and alert the SOAR platform 102 regarding the receipt of a phishing email, for example, by a mail server of the monitored network. Phishing emails may be identified based on uniform resource locator (URL)/uniform resource identifier (URI) information, Internet Protocol (IP) addresses, and/or email addresses. Further, the received actionable alert data at 104-3 can be a Security Information and Event Management (SIEM) alert. SIEM tools may generate SIEM alerts, for example, by aggregating data from different internal sources of the monitored network to identify anomalous behavior that may be indicative of a cyberattack. Furthermore, other actionable alerts can be received at 104-4 by SOAR platform 102, for example, from solutions and software applications related to Endpoint Detection and Response (EDR) tools and/or services, an Intrusion Detection System (IDS) and so forth. Additional actionable alerts can be received by the SOAR platform 102 from threat intel sources at 104-5. In an embodiment, additional actionable alerts can be received by the SOAR platform 102, for example, from susceptible indicators, syslog, manually created alerts and so forth.

As an example, SOAR platform 102 may analyze the received alert data so identify and make use of various resources (e.g., information technology (IT) case management 106-1, IT automation 106-2, security tools 106-3, and external services 106-4) to efficiently investigate, manage and/or mitigate the threats. An analyst may perform one or more IT manual tasks 108-1 as part of an incident response or assign may make use of IT case management 106-1 to assign performance of such tasks by an IT administrator, for example. Additionally or alternatively, an analyst may make use of IT automation tools 106-2 to perform one or more IT automated tasks 108-2. In some cases, the threat may be analyzed by performing one or more security manual tasks 108-3 with security tools 106-3 (e.g., EDR, network traffic analysis (NTA) and the like). For example, responsive to an particular incident or type of incident an analyst may take remedial actions (e.g., disable a user account, block a particular IP address or URL, etc.) or collect additional information regarding the incident. Similarly, an analyst may make use of various external services 106-4 as part of an incident investigation. For example, an analyst may query a Domain Name System Database (DNSDB) to find related DNS digital artifacts to a suspicious domain or IP address.

Upon initiating an investigation into an incident identified by the received alert data, in an embodiment, the SOAR platform 102 can based on the received alert data facilitate generation of a mind map view within a GUI of a console used by an analyst. The mind map view can include a primary node corresponding to the incident at issue, one or more field nodes associated with the primary node and one or more action nodes based at least on one of the one or more field nodes. Depending upon the particular implementation, the field nodes may represent any of a rule, an investigation phase, an IP address, a domain, an alert type, an alert severity, an alert status, and an alert source. The action nodes may be associated with one or more dynamic actions selectable by the analyst. The dynamic actions may generally relate to automated or manual enrichment or mitigation actions. Non-limiting examples of dynamic actions include blocking, blacklisting, termination, isolation, scanning and enriching incident at issue. The generated one or more field nodes can be attached with the primary node, and the one or more action nodes can be attached with the corresponding at least one of the one or more field nodes. Further, the one or more field nodes and the corresponding one or more action nodes can be suggested by a machine-learning engine, based on the incident at issue and its similarity to a past incident and the actions taken by analysts on the past similar incident.

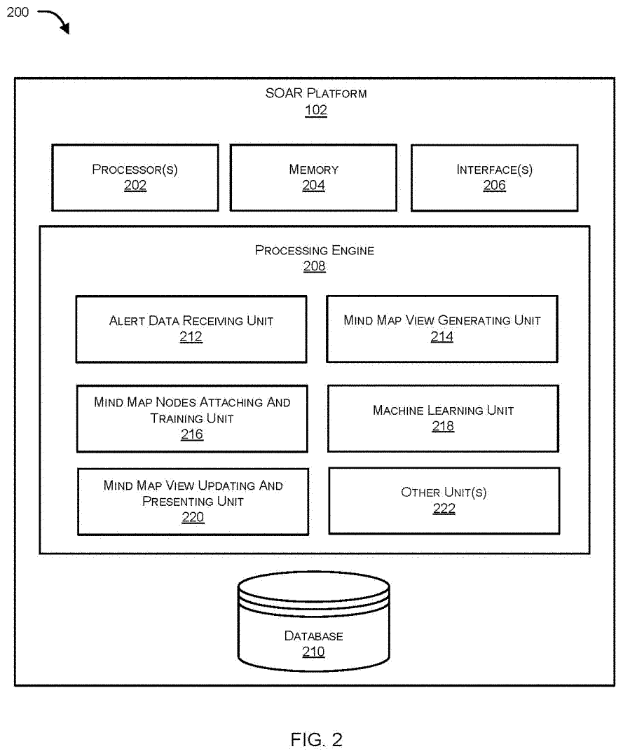

FIG. 2 is a block diagram 200 illustrating functional components of a SOAR platform 102 in accordance with an embodiment of the present invention. In the context of the present example, the SOAR platform 102 includes one or more processing resources (e.g., processor(s) 202). Processor(s) 202 can be implemented as one or more microprocessors, microcomputers, microcontrollers, digital signal processors, central processing units, logic circuitries, and/or any devices that manipulate data based on operational instructions. Among other capabilities, processor(s) 202 are configured to fetch and execute computer-readable instructions stored in a memory 204. Memory 204 can store one or more computer-readable instructions or routines, which may be fetched and executed to create or share the data units over a network service. Memory 204 can include any non-transitory storage device including, for example, volatile memory such as RAM, or non-volatile memory such as EPROM, flash memory, and the like. In an example embodiment, memory 204 may be a local memory or may be located remotely, such as a server, a file server, a data server, and the Cloud.

The SOAR platform 102 can also include one or more interface(s) 206. Interface(s) 206 may include a variety of interfaces, for example, interfaces for data input and output devices, referred to as I/O devices, storage devices, and the like. Interface(s) 206 may facilitate communication of SOAR platform 102 with various devices. Interface(s) 206 may also provide a communication pathway for one or more components of SOAR platform 102. Examples of such components include, but are not limited to, processing engine(s) 208 and database 210.

Processing engine(s) 208 can be implemented as a combination of hardware and software or firmware programming (for example, programmable instructions) to implement one or more functionalities of engine(s) 208. In the examples described herein, such combinations of hardware and software or firmware programming may be implemented in several different ways. For example, the programming for the engine(s) may be processor executable instructions stored on a non-transitory machine-readable storage medium and the hardware for engine(s) 208 may include a processing resource (for example, one or more processors), to execute such instructions. In the examples, the machine-readable storage medium may store instructions that, when executed by the processing resource, implement engine(s) 208. In such examples, SOAR platform 102 can include the machine-readable storage medium storing the instructions and the processing resource to execute the instructions, or the machine-readable storage medium may be separate but accessible to SOAR platform 102 and the processing resource. In other examples, processing engine(s) 208 may be implemented by electronic circuitry. Database 210 can include data that is either stored or generated as a result of functionalities implemented by any of the components of processing engine(s) 208.

In an example, processing engine(s) 208 can include an alert data receiving unit 212, a mind map view generating unit 214, a mind map nodes attaching and training unit 216, a machine learning unit 218, and a mind map view updating and presenting unit 220. Other unit (s) 224 can implement functionalities that supplement applications or functions performed by SOAR platform 102 or processing engine(s) 208.

In an embodiment, alert data receiving unit 212 can receive alert data pertaining to an incident. The SOAR platform 102 can be operatively coupled with a Security Operation Center (SOC) of a monitored network. During threat/incident investigation and based on the received alert data, the mind map view generating unit 214 may generate a mind map view within a GUI of a console used by an analyst. The mind map view can include a primary node corresponding to the received alert data, one or more field nodes associated with the primary node, one or more action nodes based at least on one of the one or more field nodes. Each of the one or more action nodes can be associated with one or more dynamic actions selected by the analyst and to be executed by SOAR platform 102.

Mind map nodes attaching and training unit 216 can attach the generated one or more field nodes with the primary node, and the one or more action nodes with the corresponding at least one of the one or more field nodes. Further, mind map nodes attaching and training unit 216 may be responsible for feeding information to the machine learning unit 218. For example, the mind map nodes attaching and training unit 216 may extract features of the incident at issue to form a feature set and provide the feature set along with information regarding actions taken by an analyst with respect to the incident at issue to the machine learning unit 218.

Machine learning unit 218 is responsible for learning associations among incidents, field nodes and actions based on observed actions taken by analysts with respect to incidents. Machine learning unit 218 is also responsible for providing suggested field nodes and actions for a given incident based on the given incident's similarity to prior observed incidents and interactions relating thereto. These suggestions may be used to generate a mind map visualization. According to one embodiment, a term frequency-inverse document frequency (TF-IDF) mechanism is used as statistical measure to evaluate and determine how similar a feature set associated with an incident being evaluated is to feature sets associated with one or more other incidents. According to one embodiment, the feature set for computing similarity amongst the incidents may be configurable. For example, two incidents can be determined to be similar if their names are similar, and similar indicators are linked to both the incidents. The analyst can select additional attributes from a set of attributes defined on incident metadata and the attributes can then constitute the feature set. As will be appreciated by those skilled in the art, incident metadata may include, but is not limited to a name assigned to the threat and other attributes, for example, NetFlow/Internet Protocol Flow Information Export (IPFIX) records, URL/URI information, packet headers, source and destination IP addresses, protocol, payload sizes, whether the payload is encrypted, type of encryption, certificate information, flows, network session data, email addresses, location, time, Session Initiation Protocol (SIP) request information, HTTP response codes, DNS queries, filenames, file hashes, and other indicators. Further, an exact match can be considered while computing similarity of the two incidents. In addition, a type of analyzer applied to the attributes can be configurable in nature.

Mind map view updating and presenting unit 220 is responsible for updating the mind map view in real-time such that the updated mind map view includes the suggested one or more field nodes attached to the primary node and the suggested one or more action nodes attached with the corresponding at least one of the one or more field nodes. Thereafter, the updated mind map view can be presented within the GUI so as to facilitate use of the presented mind map view for performance of a SOAR investigation into the incident at issue.

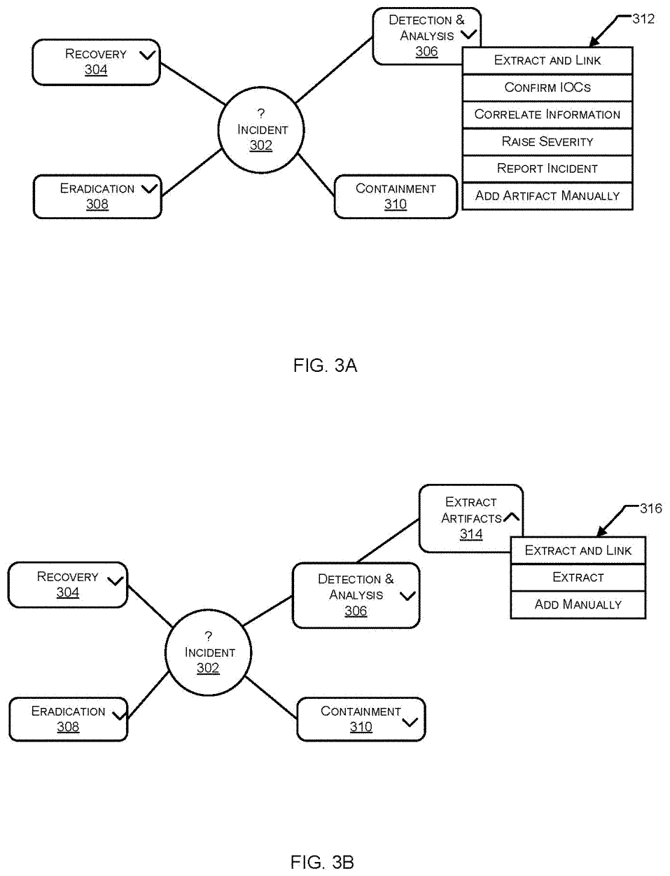

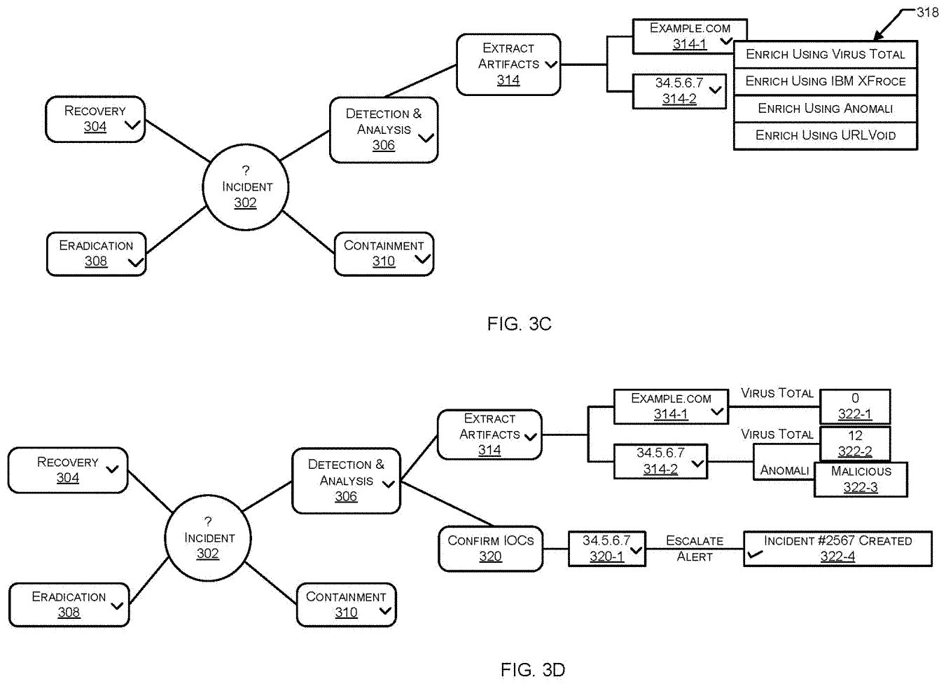

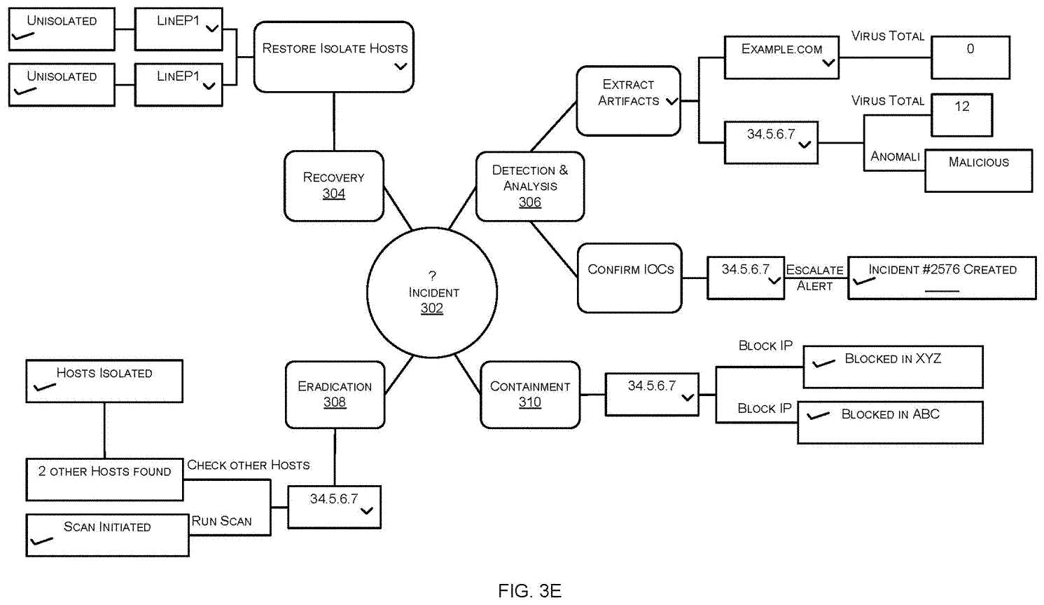

FIGS. 3A-E illustrate exemplary representations of various stages of a mind map approach to a SOAR threat investigation in accordance with an embodiment of the present invention. In the context of the present example, the mind map is a graphical representation of information that can be used to visually organize information. Typically, the mind map will be presented in a form of a hierarchical arrangement of nodes (representing various entities, for example, incidents, indicators, and assets) to illustrate the relationships among the various available entities. As explained further below, in one embodiment, one or more static nodes of a mind map may be selected to show corresponding dynamic actions that can be executed for that node. In the following embodiments mechanics of the mind map creation and representation for the SOAR threat investigation are described.

In an embodiment, the mind map based approach to a SOAR threat investigation involves high-level themes relating to visualization, actions, and machine learning. For example, in relation to visualization, instead of a tabular representation of data, a SOC record can be shown in a format based on a mind map graphical depiction that may illustrate phases, data fields, data relationships, and available actions corresponding to an incident associated with a received alert. The phases of the mind map may range from creation of a primary node, identifying appropriate field nodes for the primary node and associating appropriate action nodes with the field nodes.

In one embodiment, the primary node may represent any of an alert, an incident, and an indicator. The field nodes may each represent any type of entity recognized within the SOAR platform, for example, a rule, an investigation phase, a related alert, a related indicator, a related incident, a related IP address, a related domain, a related media access control (MAC) addresses, a related URL, a related email address, a related file, a related file hash, a related user, a related asset, a related task and so forth. Data fields of the mind map can be shown in the primary node or in an overlay panel and can include, for example, a rule name, a source tool, a creation date, a status, a severity level and so forth. The data relationships in the mind map may be illustrated by connections between the primary node and the one or more field nodes and the corresponding one or more action nodes. The action nodes can also be displayed as being connected to either of the primary node or the related connected one or more field nodes.

FIG. 3A illustrates an initial stage of a mind map for investigation of an incident at issue 302 in accordance with an example embodiment. In the context of this example, a primary node is presented representing the incident 302 with paths leading to one or more first-level field nodes each of which may provide a set of actions that may be taken. The first-level field nodes may each represent a particular phase of investigation pertaining to the incident 302. Depending upon the particular implementation, field nodes and the action nodes may be static nodes with no associated actions or dynamic nodes having associated therewith a list of dynamic actions. Depending upon the particular context, the dynamic actions may include blocking, blacklisting, whitelisting, termination, isolating, scanning, blacklisting, querying, quarantining, detonating, closing, creating, updating, deleting, escalating, adding comment to, parsing, or otherwise running actions on the incident at issue 302 or a related entity.

In an embodiment, the primary node may be connected to the one or more field nodes and the one or more field nodes may be connected to the one or more action nodes using dynamic relationships. The dynamic relationships may be based on, for example, source or destination IP addresses, hostnames of external indicators or internal assets, files and/or file hashes, users/actors/personnel involved, similar alerts, related incidents, etc.

As illustrated in FIG. 3A, an initial stage of the mind map may present to the analyst a primary node representing the incident at issue 302 (e.g., receipt of a potential phishing email) detected within the monitored network. The primary node may further include paths leading to one or more field nodes. In the context of the present example, the one or more field nodes are first-level field nodes (e.g., a recovery node 304, a detection and analysis node 306, an eradication node 308, and a containment node 310) each representing a particular phase of investigation pertaining to the incident 302.

In the context of the present example, the detection and analysis node 306 is a dynamic node and is associated with an action node 312 having a list of suggested actions (e.g., enrichment and/or mitigation actions). The list of suggested actions (e.g., extract and link, confirm indicators of compromise (IOCs), correlate information, raise the severity of the incident, report the incident, or add an artifact manually) may be displayed, for example, within a pop-up window or a dropdown list, responsive selection of the detection and analysis node 306. Those skilled in the art will appreciate various other GUI-based display/input mechanisms may be used to display the list of suggested actions for the action node 312. Similarly, the list of suggestion actions may contain more or fewer suggested actions depending upon the context (e.g., which of the field nodes 304, 306, 308 or 310). The list of suggested actions may be displayed contextually depending on the type of node selected, for example, selection of an IP address indicator may cause a different list of suggested actions to be displayed than a file hash indicator or an analyst's record.

In an embodiment, after an action is selected from an action node (e.g., action node 312), the selected action may be performed on the incident 302 associated with the primary node or some other the field node connected to the primary node. Performance of the action may be manually performed by the analyst, automatically performed by the SOAR platform, or a combination of manual and automatic actions. The action may include operations that are dependent upon another tool (e.g., a security tool). For example, the action may query another tool or request an operation to be performed by another tool.

In an embodiment, in addition to performance of the selected action, responsive to the selection of an action from an action node (e.g., action node 312), a new field node may be created and linked to the field node from which the action was selected. Assuming in the context of FIG. 3A, the analyst has selected the extract and link action from the list of suggested actions associated with action node 312, FIG. 3B illustrates an example of the creation of a new field node connected to field node 306.

FIG. 3B illustrates a second stage of the mind map of FIG. 3A in which the mind map is dynamically updated in real-time responsive to an analyst starting down the path of detection and analysis in accordance with an example embodiment. In the context of the present example, it is assumed the analyst has selected the extract and link action from the list of suggestion actions associated with node 312 of FIG. 3A. In one embodiment, responsive to the selection, a new extract artifacts node 314 may presented to the analyst via the GUI. As above, responsive to selection of the extract artifacts node 314, a list of suggested actions 316 may be presented to the analyst via a dropdown list, pop-up window or other GUI tool. As above, responsive to receipt of a selection from the list of suggested actions 316, the selected action may be performed, a new field node may be created and linked to the field node from which the action was selected, and the GUI may be dynamically updated.

In an embodiment, the selected actions can be taken on the primary node or any of the field node connected to the primary record. The actions taken can be predefined in SOAR playbooks or can be dynamic actions and operations that query or perform actions on other tools. The actions can be displayed contextually depending on the record type, for example, an IP address indicator can display a different set of actions than a file hash indicator or an analyst's record.

Assuming in the context of FIG. 3B, the analyst has selected the extract and link action from the list of suggested actions 316, FIG. 3C illustrates an example of the creation of a new field node connected to field node 314.

FIG. 3C illustrates a subsequent stage of the mind map of FIG. 3B in which the mind map is dynamically updated in real-time responsive to an analyst continuing down the path of detection and analysis in accordance with an example embodiment. In the context of the present example, it is assumed the analyst has selected the extract and link action from the list of suggestion actions 316 of FIG. 3B. In the context of the present example, two artifacts (e.g., a domain name and a IP address) are extracted and an additional node 314-1 and 314-2 is displayed for each. In the context of the present example, at this point, selection of node 314-1 results in display of yet another list of suggestion actions 318, including enrich using virus total, enrich using IBM XForce, and so forth.

As can be appreciated by those skilled in the art, the dynamic actions that are executed may produce one or more new dynamic nodes or one or more static nodes with final outputs, depending on the action that is taken. If an output of the action creates an indicator or some other data type upon which a further action can be taken then selection of the new node can display a list of additional suggested actions and so on until a leaf node is reached. Examples of leaf nodes are depicted in FIG. 3D.

FIG. 3D illustrates a subsequent stage of the mind map of FIG. 3C in which the analyst has completed enrichment of indicators 314-1 and 314-2 and has further taken a new path from the detection and analysis node 306 and created a new confirm IOCs path via confirm IOCs node 320. In the context of the present example, the mind map now includes another indicator node 320-1 and leaf nodes 322-1, 322-2, 322-3 and 322-4.

FIG. 3E illustrates a state of a mind map in which an analyst has followed various paths through the mind map via each of detection and analysis 306, containment 310, eradication 308 and recovery 304 in accordance with an example embodiment. As will be appreciated by those skilled in the art and as illustrated by FIGS. 3A-E the mind map may be dynamically expanded and updated as the analyst traverses a particular path during investigation of the incident. For example, the investigation can expand the web of nodes and paths of the mind map until an analyst closes and/or resolves the incident at issue. When the analyst closes and/or resolves the incident, the nodes of the mind map may be locked in a place while preventing further updates. Subsequently, in one embodiment, the locked and generated mind map visualization can be viewed and no longer modified as the incident has been resolved.

In an embodiment, the one or more field nodes, the corresponding one or more action nodes of the mind map and/or the list of suggested actions are suggested by a machine-learning engine (e.g., machine learning unit 281) based on observations of actions taken on similar incidents by other analysts.

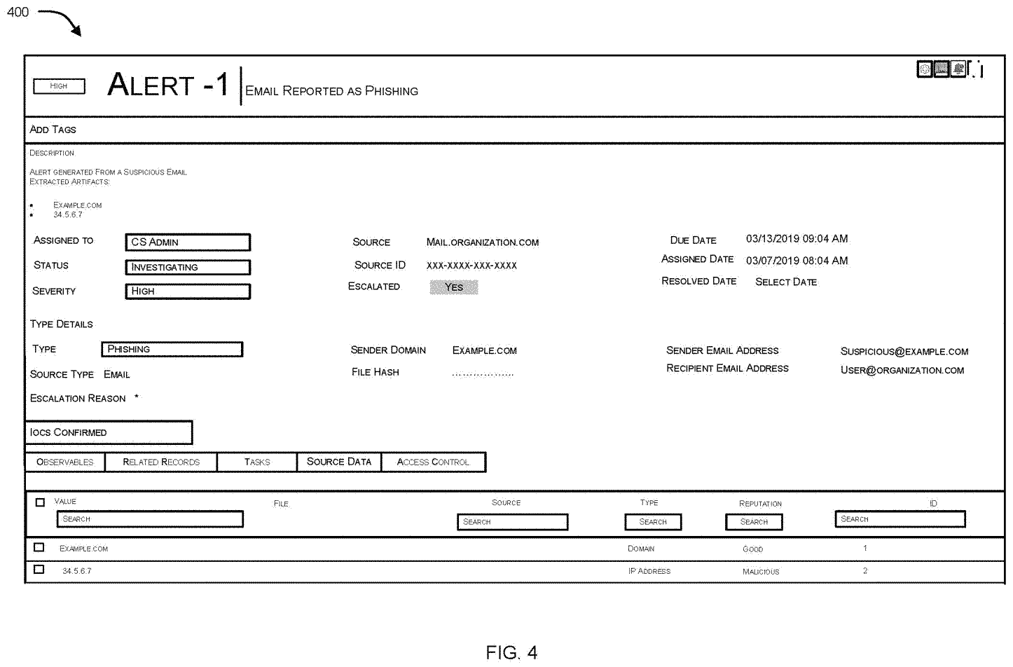

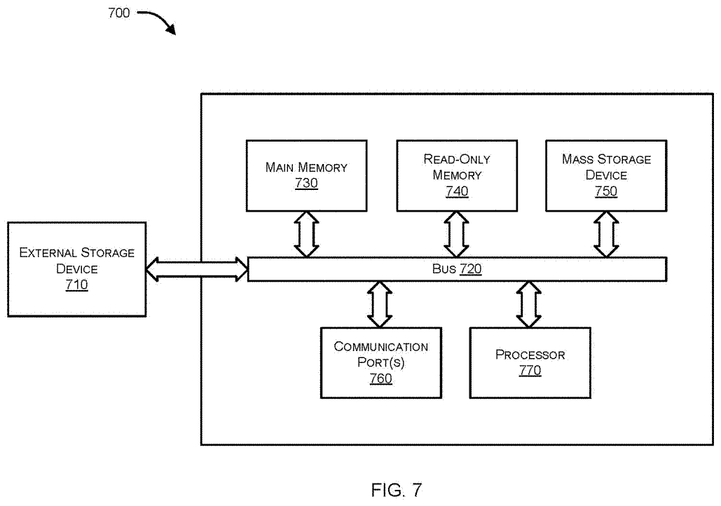

The processing described with reference to FIGS. 4-6 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, this processing may be performed by one or more computer systems of various forms (e.g., virtual and/or physical), such as the computer system 700 described with reference to FIG. 7 below.

FIG. 4 illustrates an exemplary screen shot 400 containing event data gathered via a mind map in accordance with an embodiment of the present invention. In the context of the present example, screen shot 400 summarizing the information collected during the incident investigation via the mind map depicted in FIGS. 3A-E.

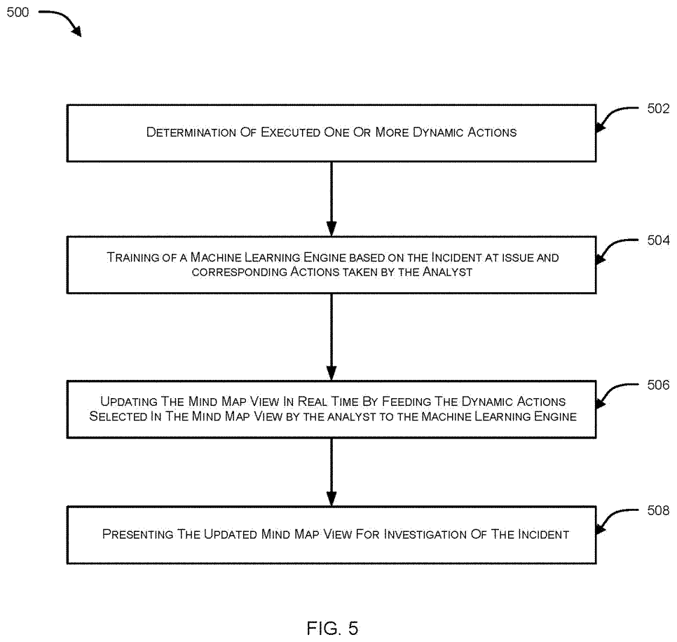

FIG. 5 is a flow diagram 500 illustrating interactions between a machine learning model and the investigation process performed via a mind map in accordance with an embodiment of the present invention. In the present example, the machine learning model is both trained based on actions taken by an analyst and used to suggest nodes and/or a list of actions for display within the mind map. Prior to block 502 it is assumed an alert has been received regarding an incident and the analyst has proceeded with an investigation of the incident using a mind map view of a GUI provided by the SOAR platform. In the context of the present example, at block 502, a determination is made regarding dynamic actions taken by the analyst. For example, with reference to FIG. 3A, information may be captured regarding the analyst's selection of the extract and link action from the list of suggested actions 312.

At block 504, a machine-learning engine (e.g., machine learning unit 218) is trained based on the incident at issue (e.g., incident 302) and corresponding actions taken by the analyst. For example, the information captured at block 502 may be fed into the machine-learning engine.

At block 506, the mind map view is updated in real time by feeding the dynamic actions selected in the mind map view to the machine learning engine. In one embodiment, based on the selected action, the incident at issue, the similarity of the incident at issue to previously observed incidents and the actions taken by analysts during investigation of similar incidents that have been previously observed, the machine learning engine suggests a new node and/or a list of actions for display within the mind map responsive to the selected action.

At block 508, the updated mind map view can be presented within the GUI of a console used by an analyst to facilitate a SOAR investigation of the incident. In one embodiment, the suggested one or more dynamic actions can be highlighted on a GUI view. The highlighted suggestion can pertain to a confidence level associated with the at least one of the predicted one or more dynamic actions. In one embodiment, the trained mind map view facilitates in improving a list of suggested actions that can be selected and executed based on the primary node, and enables highlighting relationships of interest.

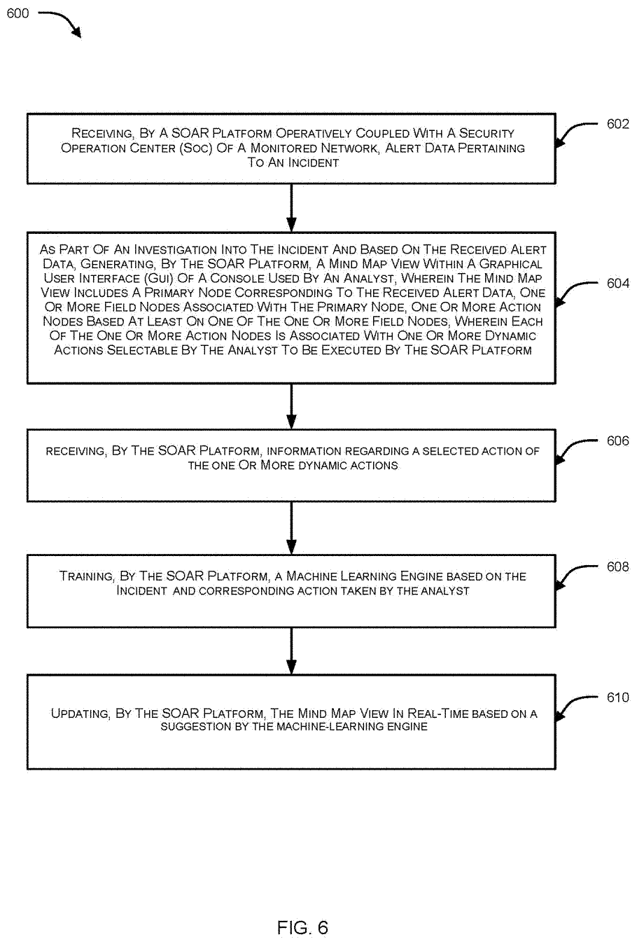

FIG. 6 is a flow diagram 600 illustrating a process for investigating a Security Operations Center (SOC) threat using a mind map in accordance with an embodiment of the present invention.

At block 602, a SOAR platform operatively coupled with an SOC of a monitored network receives alert data pertaining to an incident. For example, as part of a managed service provided by a MSSP, EDR, IDS and/or SIEM alerts associated with the monitored network may be sent to the SOAR platform for handling (e.g., investigation, mitigation and/or resolution).

At block 604, as part of an investigation into the incident and based on the received alert data, the SOAR platform generates a mind map view within a GUI of a console used by an analyst. According to one embodiment, the mind map view includes a primary node corresponding to the incident, one or more field nodes associated with the primary node, and one or more action nodes based at least on one of the one or more field nodes. Each of the one or more action nodes may be associated with one or more dynamic actions selectable by the analyst to be executed by the SOAR platform.

At block 606, the SOAR platform receives information regarding a selected action of the one or more dynamic actions.

At block 608, a machine learning engine is trained by the SOAR platform based on the incident and the corresponding action taken by the analyst. For example, based on the selected action received at block 606, the SOAR platform may feed appropriate information to the machine learning engine to train the machine learning engine regarding actions to be suggested to analysts investigating similar incidents in the future.

At block 610, the SOAR platform updates the mind map view in real-time based on a suggestion by the machine-learning engine. For example, responsive to the selected action received at block 606, the SOAR platform may request a suggestion from the machine-learning engine based on the incident at issue and the selected action. In this case, the suggestion by the machine-learning engine may be a new node to add to the mind map representing a suggested next step in the investigation of the incident.

FIG. 7 illustrates an exemplary computer system 700 in which or with which embodiments of the present invention may be utilized. As shown in FIG. 7, computer system includes an external storage device 710, a bus 720, a main memory 730, a read only memory 740, a mass storage device 750, a communication port 760, and a processor 770.

Those skilled in the art will appreciate that computer system 700 may include more than one processor 770 and communication ports 760. Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention.

Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system connects.

Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g. start-up or BIOS instructions for processor 770.

Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, and a cursor control device, may also be coupled to bus 720 to support direct operator interaction with computer system. Other operator and administrative interfaces can be provided through network connections connected through communication port 760. External storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method comprising:
receiving, by a Security Orchestration, Automation and Response (SOAR) platform, alert data pertaining to an incident observed within a monitored network;
as part of an investigation into the incident and based on the received alert data, generating, by the SOAR platform, a mind map view within a graphical user interface (GUI) of a console used by an analyst, wherein the mind map view includes a primary node corresponding to the incident, one or more field nodes associated with the primary node, one or more action nodes based at least on one of the one or more field nodes, wherein each of the one or more action nodes is associated with one or more dynamic actions selectable by the analyst to be executed by the SOAR platform;
receiving, by the SOAR platform, information regarding a selected action of the one or more dynamic actions selected by the analyst;
training, by the SOAR platform, a machine-learning model based on the incident and the selected action; and
updating, by the SOAR platform, the mind map view in real-time based on a suggestion by the machine-learning model.

2. The method of claim 1, wherein the one or more field nodes each represent an investigation phase.

3. The method of claim 1, wherein a dynamic action of the one or more dynamic actions represents an enrichment action or a mitigation action.

4. The method of claim 3, wherein the enrichment action enriches an artifact associated with the incident with threat intelligence.

5. The method of claim 1, wherein a dynamic action of the one or more dynamic actions causes the SOAR platform to issue an operation to a security tool associated with the monitored network.

6. The method of claim 4, wherein the operation causes the security tool to block an Internet Protocol (IP) address associated with the incident

7. The method of claim 1, wherein the incident pertains to any or a combination of an unknown new threat, a known new threat, an unknown one-off threat, a known one-off threat, an unknown probable threat, and a known probable threat.

8. A non-transitory computer-readable storage medium embodying a set of instructions, which when executed a processing resource of a Security Orchestration, Automation and Response (SOAR) platform, causes the processing resource to perform a method comprising:
receiving alert data pertaining to an incident observed within a network monitored by the SOAR platform;
as part of an investigation into the incident and based on the received alert data, generating a mind map view within a graphical user interface (GUI) of a console used by an analyst, wherein the mind map view includes a primary node corresponding to the incident, one or more field nodes associated with the primary node, one or more action nodes based at least on one of the one or more field nodes, wherein each of the one or more action nodes is associated with one or more dynamic actions selectable by the analyst to be executed by the SOAR platform;
receiving information regarding a selected action of the one or more dynamic actions selected by the analyst;
training a machine-learning model based on the incident and the selected action; and
updating the mind map view in real-time based on a suggestion by the machine-learning model.

9. The non-transitory computer-readable storage medium of claim 8, wherein the one or more field nodes each represent an investigation phase.

10. The non-transitory computer-readable storage medium of claim 8, wherein a dynamic action of the one or more dynamic actions represents an enrichment action or a mitigation action.

11. The non-transitory computer-readable storage medium of claim 10, wherein the enrichment action enriches an artifact associated with the incident with threat intelligence.

12. The non-transitory computer-readable storage medium of claim 8, wherein a dynamic action of the one or more dynamic actions causes the SOAR platform to issue an operation to a security tool associated with the monitored network.

13. The non-transitory computer-readable storage medium of claim 12, wherein the operation causes the security tool to block an Internet Protocol (IP) address associated with the incident

14. The non-transitory computer-readable storage medium of claim 8, wherein the incident pertains to any or a combination of an unknown new threat, a known new threat, an unknown one-off threat, a known one-off threat, an unknown probable threat, and a known probable threat.

15. A Security Orchestration, Automation and Response (SOAR) system comprising:
a processing resource; and
a non-transitory computer-readable medium, coupled to the processing resource, having stored therein instructions that when executed by the processing resource cause the processing resource to perform a method comprising:
receiving alert data pertaining to an incident observed within a network monitored by the SOAR system;
as part of an investigation into the incident and based on the received alert data, generating a mind map view within a graphical user interface (GUI) of a console used by an analyst, wherein the mind map view includes a primary node corresponding to the incident, one or more field nodes associated with the primary node, one or more action nodes based at least on one of the one or more field nodes, wherein each of the one or more action nodes is associated with one or more dynamic actions selectable by the analyst to be executed by the SOAR system;
receiving information regarding a selected action of the one or more dynamic actions selected by the analyst;
training a machine-learning model based on the incident and the selected action; and
updating the mind map view in real-time based on a suggestion by the machine-learning model.

16. The system of claim 15, wherein the one or more field nodes each represent an investigation phase.

17. The system of claim 16, wherein a dynamic action of the one or more dynamic actions represents an enrichment action or a mitigation action.

18. The system of claim 17, wherein the enrichment action enriches an artifact associated with the incident with threat intelligence.

19. The system of claim 15, wherein a dynamic action of the one or more dynamic actions causes the SOAR platform to issue an operation to a security tool associated with the monitored network.

20. The system of claim 19, wherein the operation causes the security tool to block an Internet Protocol (IP) address associated with the incident
